(19) United States
(12) Patent Application Publication
(10) Pub. No.: US 2009/0089381 A1
(43) Pub. Date: Apr. 2, 2009

(54) PENDING AND EXCLUSIVE ELECTRONIC MAIL INBOX

(75) Inventors: Christine Anderson, San Jose, CA (US); Omar Shahine, Menlo Park, CA (US); Erez Kikin-Gil, Mountain View, CA (US); Sara Liu Yang, Fremont, CA (US); Tyler Schnoebelen, San Francisco, CA (US); Nancy Jane Bell, Menlo Park, CA (US); Wendy Chan, Palo Alto, CA (US); Thomas Jan Stovicek, Mountain View, CA (US); Sandra Hirsh, Palo Alto, CA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/864,706

(22) Filed: Sep. 28, 2007

(51) Int. Cl. G06F 15/16

(52) U.S. Cl. 709/206

(57) ABSTRACT

Distinguishing electronic mail (e-mail) messages for a user. An e-mail inbox is provided to include one or more e-mail messages therein. A first section of the inbox is specified. The first section includes a set of the one or more messages, and the set of the one or more messages is indicative of an unknown status. An second section of the inbox is provided, and the second section includes the remaining set of the one or more messages. The remaining set of the messages is indicative of a known status.

### BACKGROUND

Electronic mail (e-mail) has become one of the most used modern communication tools. An e-mail user has typically at least one e-mail account with an e-mail service provider (e.g., from a web-based source or from the user's employment) for sending and receiving electronic messages. The user also typically uses either a web browser to review e-mail messages from a web-based e-mail service provider or an e-mail client application installed on the user's computer for viewing e-mail messages.

With the popularity and convenience of e-mail, unwanted messages, such as SPAM, junk mail, or electronic advertisements, slowly but surely fill the user's e-mail inbox. As such, e-mail inboxes now include a mixture of e-mail messages. Some messages are from individuals listed in a user's contacts or address book. Others may be SPAM or unwanted messages. Furthermore, there are other e-mail messages from known sources that may or may not be welcome.

Current inbox implementations typically provide generic listings of e-mail messages that are received. For example, a user's inbox typically shows a list of messages sorted chronologically according to the time of arrival of the messages. The user may sort them by conversation (i.e., e-mail threads), sender, size, alphabetically by subject, etc. There may be other filters or mechanisms that may first filter out some e-mail messages before delivering the remaining messages to the user's inbox. Once in the inbox, however, the user usually spends time to identify unwanted messages and delete them before reading the desirable or legitimate messages intended for the user. They typically scan the sender names and subjects, looking for unwanted or unrecognized items. They are many times confused by the legitimicay of some of the e-mails, especially the ones with “re” in the title that look like they come from someone they know. This usually requires them to open the mail before learning it is offensive or unwanted. The user may also occasionally need to review messages in other folders that include filtered message, such as the folder that is designed for temporarily saved SPAM messages. This precautionary, but nevertheless necessary, action is needed to ensure that legitimate messages that may be erroneously identified as SPAM are read before they are automatically deleted by the SPAM folder. The user continues to spend more time on removing or identifying unwanted messages in the inbox.

### SUMMARY

Embodiments of the invention improve user experiences in using e-mail inboxes by providing a convenient way for the user to differentiate between safe e-mails (such as e-mail messages from contacts or known sources) and unknown mail by placing them in two separate or distinguished places in the inbox. Aspects of the invention place messages from unknown or suspicious senders in a pending section or area of the inbox while messages from safe senders are delivered in a separate or exclusive section or area of the inbox. Hence, embodiments of the invention do not further re-direct messages away from user's inbox; aspects of the invention maintain the messages in the inbox but in different sections or areas for easy recognition. Alternative embodiments of the invention enable the users to receive notifications if there are new e-mail messages in the pending section and enable the users to specify if the messages in the pending section are safe, unsafe, subject for deletion, subject for moving/archiving to another folder, or no actions needed. The messages from safe senders may then be moved to the separate or exclusive section of the inbox while messages from unsafe senders in the pending section may be treated as junk e-mail messages. Alternative aspects of the invention may keep the messages in the pending section if the users wish to ignore the pending section and dedicate their time to read only e-mail from safe list or from their contacts in the exclusive section. In this way, users would feel more in control over their inbox and reduce the feeling that bad mail or lower priority mail (like newsletters) are blocking them from getting to their good e-mail messages.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary embodiment of a system for providing electronic mail (e-mail) messages to a user in an e-mail inbox according to an embodiment of the invention.

FIGS. 2A, 2B, 2D to 2E are exemplary screen shots illustrating a pending section and an exclusive section of an inbox according to an embodiment of the invention.

FIG. 2C is an exemplary diagram illustrating three exclusive or filter settings according to an embodiment of the invention.

FIG. 2F is an exemplary diagram illustrating interactions of messages within a first section and a section of an inbox according to an embodiment of the invention.

FIG. 3 is an exemplary flow chart illustrating operation of distinguishing electronic mail (e-mail) messages for a user according to an embodiment of the invention.

FIG. 4 is a block diagram illustrating an exemplary computer-readable medium having a data structure stored thereon which aspects of the invention may be stored.

Corresponding reference characters indicate corresponding parts throughout the drawings.

### DETAILED DESCRIPTION

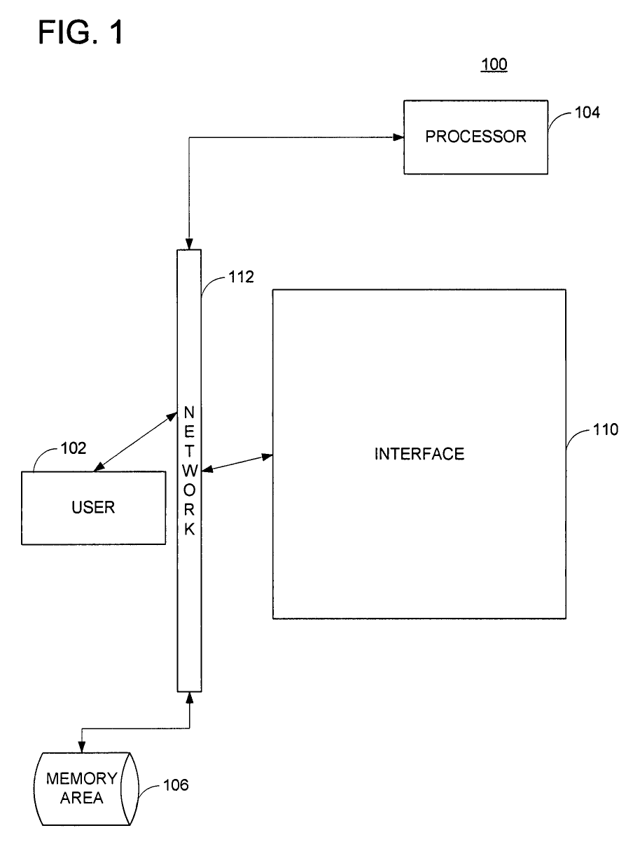

Embodiments of the invention simplify the user's experience in one's messages' inbox by differentiating messages in one's box and allowing the user to have an opportunity to read messages from safe and known senders before having to scan through messages from unknown and potentially dangerous senders. Referring now to FIG. 1, a block diagram illustrates a system 100 for providing electronic mail (e-mail) messages to a user 102 in an inbox according to an embodiment of the invention. It is to be understood that, while figures use an e-mail message for illustrations, other messages, such as faxes, voice mails, offline instant messages, private messages or the like that are delivered to the e-mail box are considered as “e-mail messages” throughout the discussions of embodiments of the invention. The system 100 may be a computing system having a server computer providing services to one or more other computers, such as client computing computers. In another embodiment, the system 100 may be a web server hosting a web site that is visited by users, such as user 102 over an intranet or internet. The system 100 includes a processor 104 executing computer-executable instructions for performing a plurality of operations. In one example, the processor 104 may execute computer-executable instructions embodied in one or more software applications, components within an application or software, executable library files, executable applets, or the like. The system 100 also includes a memory area 106 accessible by the processor 104 for storing information and data for the processor 104. For example, the memory area 104 may store data used by or accessed by the processor 104, such as software, applications, data, or the like. In another embodiment, the system 100 accesses data stored on the memory area 104 via a network 112.

In one embodiment, the memory area 104 may be volatile or nonvolatile media, removable and non-removable media, may be any available medium that may be accessed by a computer or a collection of computers (not shown). By way of example and not limitation, computer readable media include computer storage media. The computer storage media in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by the computer.

In one embodiment, the system 100 provides an interface 110 for interacting with the user 102. For example, the interface 110 may include a web site or a web portal where the user 102 may visit via a web browser software (not shown). In one aspect of the invention, the system 100 may be a web e-mail system which may include one or more other computers and database servers for receiving, storing, and sending e-mail messages on behalf of one or more users. For example and as appreciated by those known in the art, a web-based e-mail system 100 may include the user 102 having an account with the system 100 and the system 100, based on a set of user usage rules, assigns an amount of storage area for the user 102 in the memory area 106 for storing e-mail messages, data associated with the user's contact list, or the like. The processor 104 may execute computer-executable instructions or software or applications to perform operations received according to interactions from the user 102 via the interface 110. For example, the user 102 may compose an e-mail message from the interface 110 by entering the text or content of the message. It is to be understood that other operations may be provided by the processor 104 to the user 102 without departing from the scope of the embodiments of the invention.

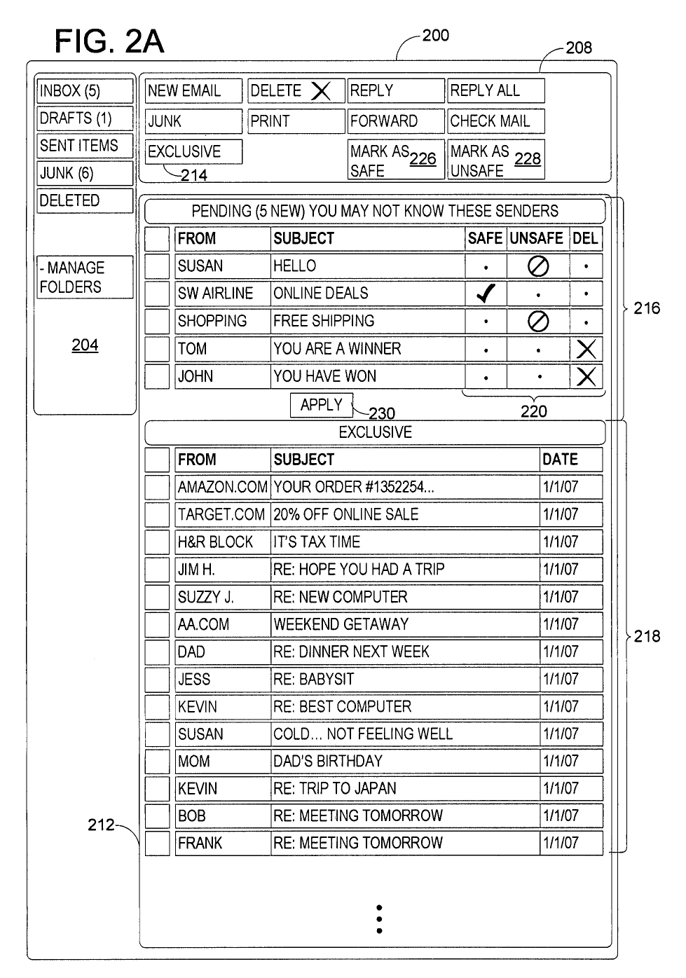

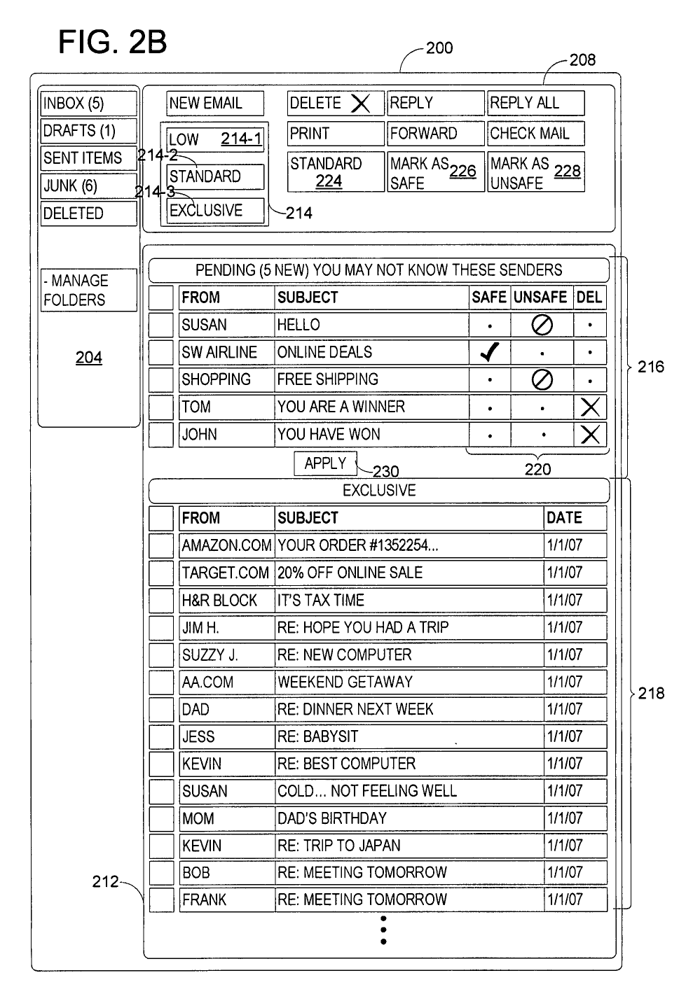

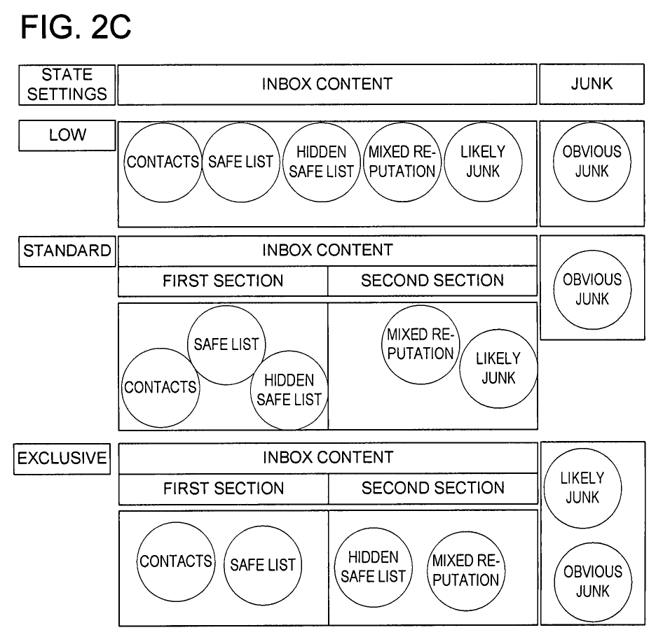

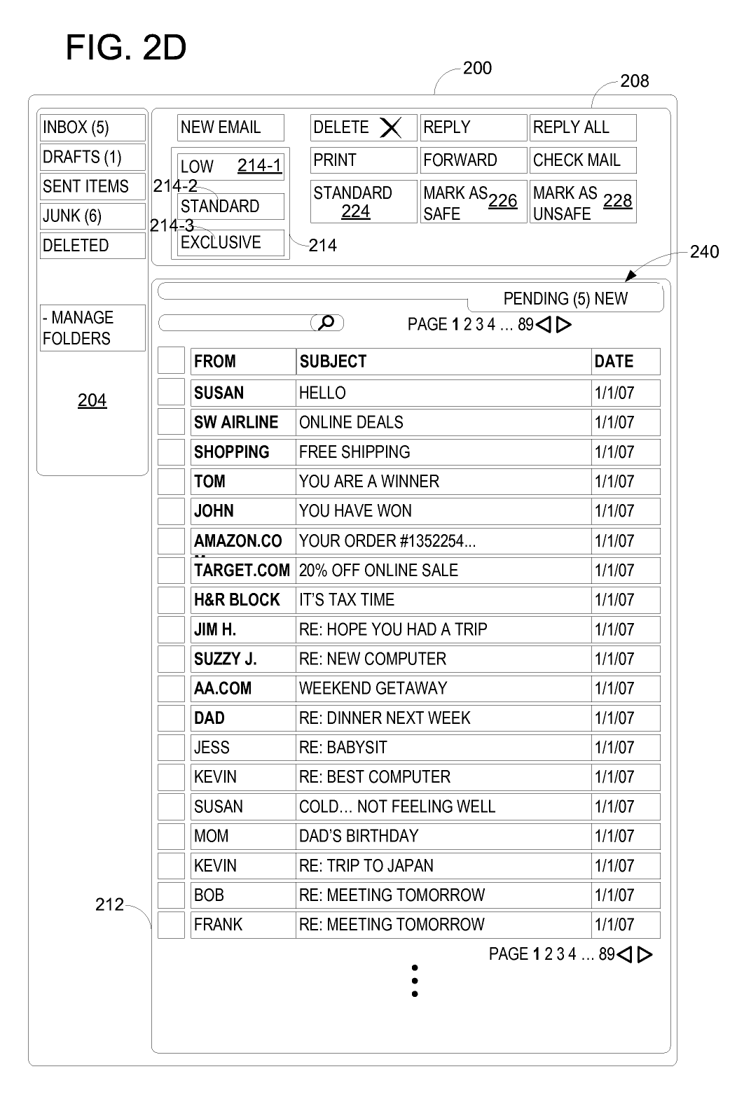

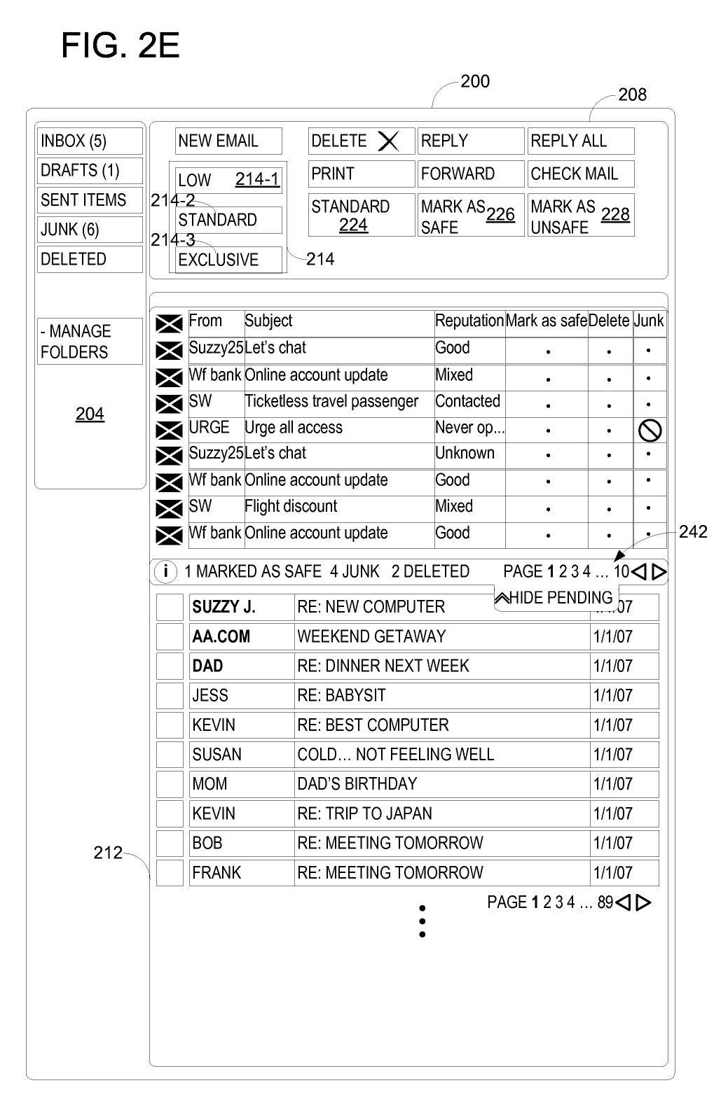

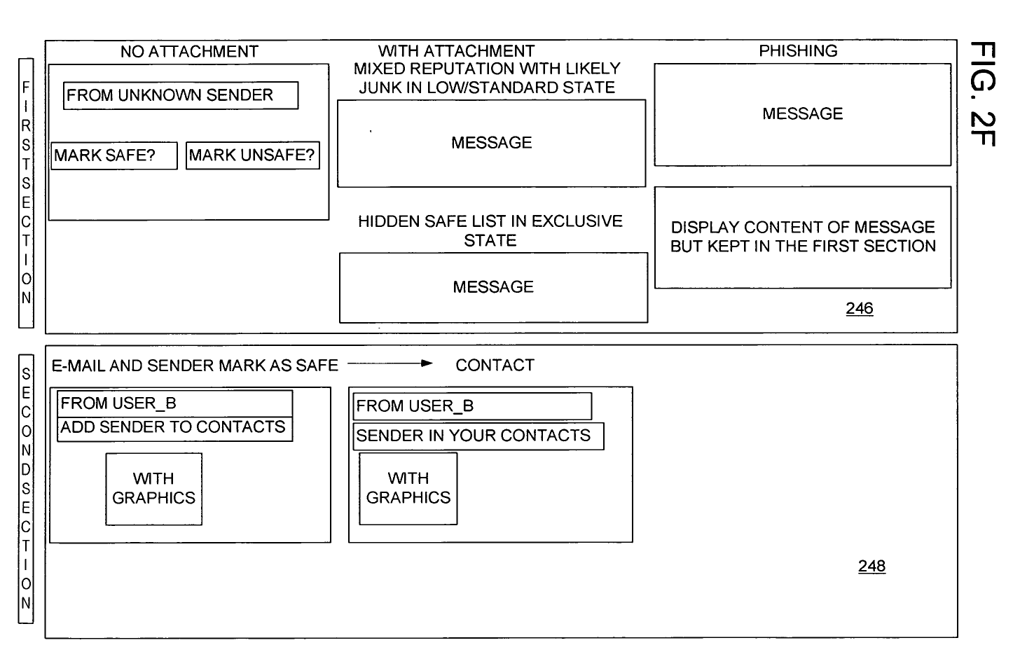

Referring now to FIG. 2A, an exemplary screen shot illustrates a pending section and an exclusive section of an e-mail inbox according to an embodiment of the invention. FIG. 2A illustrates an exemplary display screen 200 with a folder list display holder 204 and a set of e-mail operations 208. The folder list display holder 204 includes folders such as INBOX, DRAFTS, SENT ITEMS, JUNK, or DELETED. It is to be understood and appreciated that other folders or items may be included in the folder list display holder 204 without departing from the scope of the invention. The folder list display holder 204 also includes a control or a button that enables management of the folders.

The set of e-mail operations 208 includes one or more actions that a user can act on an e-mail message. For example, the set includes controls or actions, such as NEW E-MAIL, DELETE, REPLY, REPLY ALL, JUNK, PRINT, FORWARD, CHECK MAIL, EXCLUSIVE, MARK AS SAFE, STANDARD, MARK AS UNSAFE, or the like. Other actions or operations may be included without departing from the scope of the invention. The display screen 200 further includes a content area 212 where one or more e-mail messages are listed.

According to one aspect of the invention, the content area 212 of the display 200 includes an exclusive control or button 214 for enabling a pending section 216 and an exclusive section 218 of the content area 212 of the inbox. Upon activating or enabling of the exclusive feature of the e-mail inbox, the display 200 renders the pending section 216 and the exclusive section 218. The pending section 216 displays one or more messages that have inbox status data 220 associated with each one of the messages accordingly. In one example, the inbox status data 220 may indicate one or more following information about each of the messages in the pending section 216: safe preference, unsafe preference, or a deletion preference. Embodiments of the invention also enable the user to mark the message as safe/unsafe, to delete it, or to move it to the safe area of the inbox. If they choose to move it to the safe area of the inbox, aspects of the invention offer the option of moving just this one mail or all mails from this sender that are in the pending area (or maybe just future ones from this sender, but not all past ones). In other words, decisions about both the sender and mails from the sender are made through the marking of the messages according to the safe/unsafe, delete or move operations.

For example, the safe preference indicates that the user 102 wishes to define a particular e-mail message as an acceptable or legitimate e-mail message that the user 102 wishes to receive and does not wish to make additional determination as the valid. In a further example, e-mail messages that are safe may be messages from friends, relatives, or acquaintances of the user 102. Also, as another illustration, the user 102 may define an “unsafe” inbox status as being unwanted, such as junk e-mail or SPAM. The deletion preference may indicate that the user 102 wishes to delete the message without reading it. Similarly, the user 102 may elect to enable a “MARK AS SAFE” control or button 226 to mark a message “SAFE” in the pending section 216 after the user 102 highlights or selects the message. Likewise, the user 102 may elect to enable a “MARK AS UNSAFE” control or button 228 to mark a message “UNSAFE” in the pending section 216 after the user 102 highlights or selects the message. In an alternative embodiment, the user 102 may modify the inbox status data 220 by interacting (e.g., via an input device of the system accessible by the user 102) with the portion of the message under the column section of “SAFE,” “UNSAFE,” or “DEL.”

The exclusive section 218 of the content area 212 includes a header that shows information in different columns, such as FROM, SUBJECT, and DATE. Other column headings may be included without departing from the scope of the invention. In one embodiment, all messages in the exclusive section 218 indicate the inbox status data 220 as “SAFE” or “CONTACT.”

Initially, the user 102 receives all messages, and all messages are displayed in the content area 212 of the inbox. Upon activation of the EXCLUSIVE control 214, the processor 104 specifies the pending section 216 and the exclusive section 218 and separates or distinguishes the messages into two groups. The first set in the pending section 216 includes messages that have unknown inbox status data. In one example, the unknown inbox status data may be defined as an e-mail message source not included in a contact list of the user or an e-mail message source not included in a safe list defined by the user. Other definition or criterion may be established for the unknown inbox status data without departing from the scope of the embodiments of the invention. For example, UNKNOWN status may also indicate reputations of senders of the message.

On the other hand, the exclusive section 218 of the inbox of the display 200 includes messages with known inbox status data. For example, the known inbox status data may be defined to include at least one of the following statuses: a safe status and a contact status. Alternative, just because the user may not have specifically marked a particular message as “SAFE” or “CONTACT,” embodiments may nevertheless mark messages as SAFE or CONTACT if messages from a particulars have been received continuously without any adverse reaction from the user. As such, the user 102 is able to have all e-mail messages delivered to inbox while some of them being separated, distinguished, or divided into a different section of the inbox such that the user 102 has an opportunity to decide further how to define or classify the messages. In a further aspect of the invention, the user 102 may modify the inbox status data 220 of the messages in the pending section 216 and the processor 104 may move the messages with the modified inbox status data to the exclusive section 218 or other folders. For example, as illustrated in FIG. 2A, the user 102 may use an input device, such as a computer mouse, to modify the inbox status data 220 of a particular message and such modification is persisted or made permanent when the user 102 selects an “APPLY” control or button 230. In one embodiment, the user 102 may modify a group of messages in the pending section 216 of the inbox by using a square check box in front of the messages and the one or more controls or buttons in the set of operations 208.

As such, embodiments of the invention enable the user 102 to have enhanced user experience in controlling how the e-mail messages are received and organized in the inbox and enabling the user to set viewing preferences based on the inbox status data. The user 102 can then quickly focus on the legitimate or “good” messages by quickly viewing the messages in the exclusive section 218 of the inbox. In an alternative embodiment, the user 102 may completely ignore the messages in the pending section 216 and the messages in the pending section 216 may be automatically removed or deleted after a predetermined time period by the processor 104.

In one embodiment, the exclusive button 214 is further divided to three separation buttons with three states. FIG. 2B illustrates such embodiment having a low state 214-1, a standard state 214-2, and an exclusive state 214-3. By choosing one of the states, the user can both set their junk mail filter and activating the pending/safe areas in this embodiment. For example, when the user chooses Low state 214-1, the users are indicating that the users wish to have the lowest amount of filtering and thus most of the mail, even ones are somewhat suspect end up in the inbox. At the same time, choosing Low state 214-1 means the user will not see a “pending” area. Everything is in one area in the inbox.

When the user chooses “standard” state 214-2, the users are indicating the users want the filter set to a standard level where mails from suspicious senders and senders with mixed reputations will end up in a pending area or a first section of the inbox and mails from senders who are on the contact list, on the safe list, messages from people the user has sent multiple messages to but haven't added to the safe list, or messages from senders considered as having a good reputation from company where one works end up in the safe or exclusive area or a second section of the inbox. When the user chooses Exclusive state 214-3, then the users are indicating that the users wish to have the highest level of filtering. Only messages from safe senders and contacts end up in the safe area or the second section of the inbox as well as people the user has sent messages to multiple times but has not added to the contact list. Good reputation senders, however, are sent to the pending area or the first section. If the user has set the filter setting at the exclusive state 214-3, for example, embodiments of the invention enable all messages will be delivered according to the exclusive state 214-3 until further changes are made by the user.

On the other hand, if during one of the user's online sessions, the user changes the filter to standard state 214-2 or low state 214-1, the messages from the different types of senders would move into the appropriate area (such as messages from good reputation would move from the pending area or the first section to the safe area or the second section of the Inbox according to a change from the exclusive state 214-3 to the standard state 214-2). Furthermore, embodiments of the invention set the filter with the standard state 214-2 setting until further changes.

Referring now to FIG. 2C, a diagram illustrating the three sub-state settings for the exclusive button 214 according to an embodiment of the invention. In one embodiment, FIG. 2C illustrates examples describe above in a simplified method. In one example, messages that are classified as “Hidden Safe list” are messages from senders who are recipients of messages from the user but the user has yet to identify them as be “SAFE” or “CONTACT”, or messages that the user has read at least three times but the user has yet to identify them as be “SAFE” or “CONTACT”, or messages from senders who are known to have good reputation but the user has yet to identify them as be “SAFE” or “CONTACT”. In another embodiment, the mixed reputation classification includes messages such as first time personal message, some newsletters from legitimate sources, messages from some online vendors, messages with “RE:” in the subject line of the messages, or messages from senders who are not recognized by the user. It is contemplated by inventors of embodiments of the invention that other definitions or classifications may be used to define one or more sub-state of the exclusive button with filtering functionality without departing from the scope and spirit of embodiments of the invention.

FIGS. 2D and 2F further illustration additional screen shots according to embodiments of the invention and illustrate various additional features of the inbox with the Exclusive/filter functionality. For example, a feature 240 of FIG. 2D illustrates that the pending or first section of the inbox separation may be hidden in a default mode of the inbox when rendered to the user. When displaying the pending section or first section, a pagination feature 242 in FIG. 2E illustrates the controls for placing one or more messages into different pages within the pending section or the first section and the pagination feature 242 enables the user navigate from pages to pages of the pending section.

FIG. 2F is a diagram illustrating one or more interactions between different types of message classifications within the first section and the second section. For example, a first section row of the inbox 246 describes the kind of messages in the first section while a second section of the inbox 248 describes the how a user makes a message that is marked as “SAFE” to “CONTACT” within the second section of the inbox.

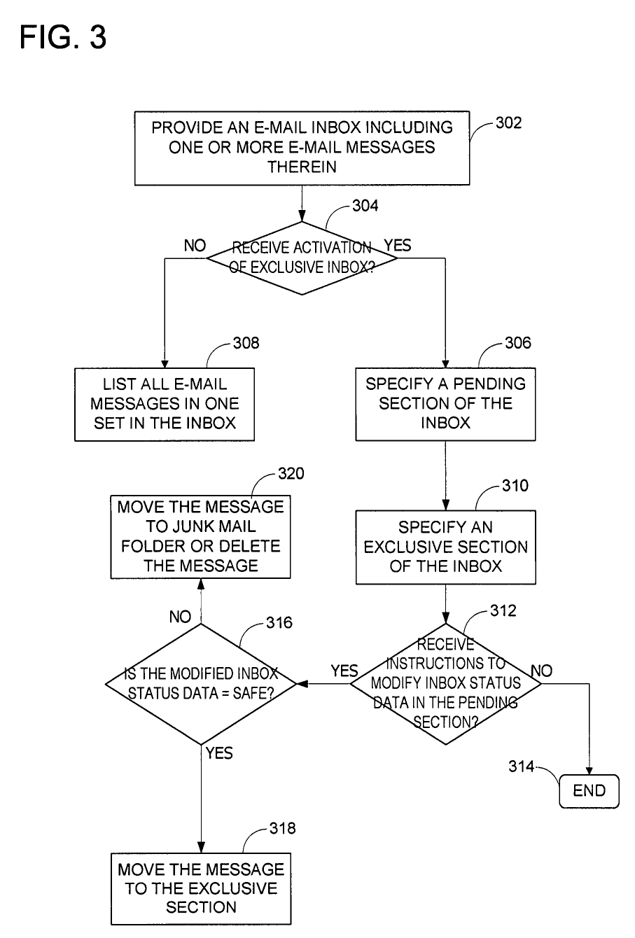

FIG. 3 is an exemplary flow chart illustrating operation of distinguishing electronic mail (e-mail) messages for a user according to an embodiment of the invention. At 302, an e-mail inbox including one or more e-mail messages therein is provided to the user. In one embodiment, a determination is made at 304 to detect or identify whether the user 102 has activated the “EXCLUSIVE” control or button 214 embodying aspects of the invention. If the determination is positive, a pending section of the inbox is specified for the user 102 at 306. The pending section includes a set of the one or more messages, and the set of the one or more messages indicate an unknown status. If the determination is negative, all messages are listed in the inbox at 308 without the pending section 216 or the exclusive section 218.

At 310, an exclusive section of the inbox is specified. The exclusive section includes the remaining set of the one or more messages, and the remaining set of the messages indicates a known status. In a further alternative embodiment, a second determination is made to identify whether an instruction is received from the user to modify the inbox status data of the messages in the pending section 216 at 312. If the determination is negative, the process ends at 314. On the other hand, if the determination is positive, a third determination is made to identify whether the modification to the inbox status data is equal to “SAFE” status at 316. If the determination is positive, the processor 104 or the system 100 modifies the inbox status data of the identified message and moves the message from the pending section 216 to the exclusive section 218 at 318. If the third determination is negative, the messages may be moved to a junk mail folder or be deleted based on an “UNSAFE” status or a “DELETED” status.

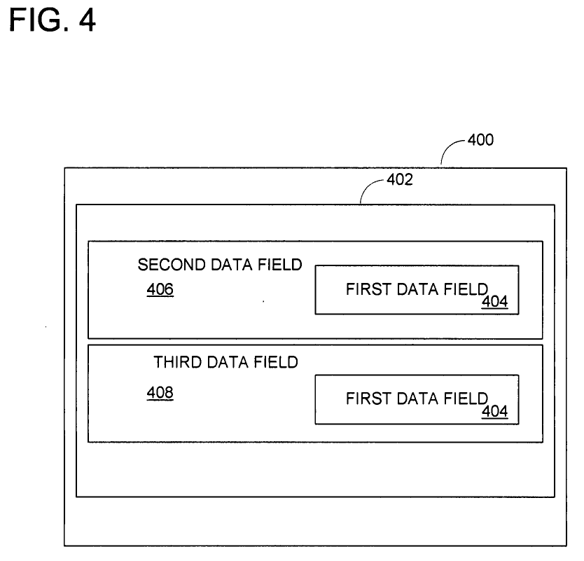

FIG. 4 is a block diagram illustrates an exemplary computer-readable medium 400 having a data structure 402 stored thereon which aspects of the invention may be stored. For example, a first data field 404 stores inbox status data for each of the one or more messages in the e-mail inbox. A second data field 406 stores data representing a first set of the one or more messages in the e-mail inbox. Each of the one or more messages in the second data field 406 specifies an unknown status in the first data field 404. The data structure 402 also includes a third data field 408 storing data representing a second set of the one or more messages in the e-mail inbox. Each of the one or more messages in the third data field 408 specifies a known status in the first data field 404.

In operation, the processor 104 executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for distinguishing messages for a user, said method comprising:
providing an inbox including one or more messages from one or more senders therein;
specifying a first section of the inbox, said first section including a set of the one or more messages from the one or more senders, said set of the one or more messages whose senders have an unknown status; and
specifying an second section of the inbox, said second section including the remaining set of the one or more messages from the one or more senders, said remaining set of the messages being indicative of a known status.

2. The method of claim 1, wherein the unknown status indicates the set of the one or more messages from the one or more senders including at least one of the following properties: a message source not included in a contact list of the user, a message source not included in a safe list defined by the user, senders with frequent message communications but without a proper status, good reputation senders, mixed reputation senders, potentially dangerous senders, and changes to distinguishing message settings.

3. The method of claim 1, further comprising receiving an instruction from the user for modifying the unknown status of the one or more messages from the one or more senders in the first section of the inbox, and further comprising providing at least one or more operations in response to the received instruction: identifying the one or more messages with the modified unknown status to the second section, relocating all messages from a sender with the modified unknown status to the first section, and relocating future messages from the sender to the second section.

4. The method of claim 3, wherein receiving comprises one or more of the following:
wherein receiving the instruction from the user for modifying the unknown status of the one or more messages in the first section of the inbox to the known status, and further comprising moving the one or more messages with the known status from the first section of the inbox to the second section of the inbox,
wherein receiving comprises receiving the instruction from the user for modifying the unknown status of the one or more messages in the first section of the inbox to an unsafe status, and further comprising moving the one or more messages with the unsafe status from the first section of the inbox to a junk e-mail storage, or
wherein receiving comprises receiving the instruction from the user for modifying the unknown status of the one or more messages in the first section of the inbox to a deleted status, and further comprising performing at least one or more of the following operations in response to the received instruction: removing the one or more messages with the deleted status from the first section of the inbox, deleting all messages from a sender with deleted status, and deleting the one or more messages with the deleted status at this time.

5. The method of claim 1, further comprising receiving a filter for specifying the first section and the second section, said filter defining at least a low state, a standard state, and an exclusive state, wherein the low state, the standard state, and the exclusive state defining one or more messages from senders based on a function of the unknown status and the known status.

6. The method of claim 5, further comprising applying the received filter to a junk folder, wherein the applied filter filters the one or more messages to the junk folder, the first section of the inbox, and the second section of the inbox as a function of the unknown status and the known status.

7. A tangible computer-readable medium having a data structure stored thereon for partitioning messages in an inbox, said data structure storing data for one or more messages, said data structure comprising:
a first data field storing inbox status data for each of the one or more messages in the inbox;
a second data field storing data representing a first set of the one or more messages from senders in the inbox,
wherein each of the one or more messages in the second data field specifying an unknown status in the first data field; and
a third data field storing data representing a second set of the one or more messages in the inbox,
wherein each of the one or more messages of the third data field specifying a known status in the first data field.

8. The tangible computer-readable media of claim 7, wherein the unknown status of the first data field indicates the first set of the one or more messages including at least one of the following properties: a message source not included in a contact list of the user, a message source not included in a safe list defined by the user, senders with frequent message communications but without a proper status, good reputation senders, mixed reputation senders, potentially dangerous senders, and changes to distinguishing message settings.

9. The tangible computer-readable media of claim 7, wherein the known status of the first data field includes at least one of the following status: a safe status and a contact status.

10. The tangible computer-readable media of claim 7, wherein the first data field is receptive to modification from the user.

11. The tangible computer-readable media of claim 9, wherein the modification comprises one or more of the following:
modifying the unknown status in the first data field of the messages in the second data field to the known status in the first data field, and wherein the messages corresponding to the modified unknown status are moved to the second set in the third data field,
modifying the unknown status in the first data field of the messages in the second data field to a safe status in the first data field, and wherein the messages corresponding to the safe status are moved to the second set in the third data field, or
modifying the unknown status in the first data field of the messages in the second data field to a deleted status in the first data field, and wherein the messages corresponding to the deleted status in the first data field are moved from the second data field.

12. The tangible computer-readable media of claim 7, further comprising a fourth data field storing a filter for specifying the first section and the second section, said filter defining at least a low state, a standard state, and an exclusive state, wherein the low state, the standard state, and the exclusive state defining one or more messages from senders based on a function of the unknown status and the known status.

13. The tangible computer-readable media of claim 12, wherein the filter of the fourth field is applied to a junk folder, wherein the applied filter filters the one or more messages to the junk folder, the first section of the inbox, and the second section of the inbox as a function of the unknown status and the known status.

14. A system for providing messages to a user in an e-mail inbox, said system comprising:
a memory area for storing one or more messages from senders in the inbox;
an interface for providing the stored messages to a user;
a processor having configured to execute computer-executable instructions for:
specifying a first section of the inbox on the interface, said first section including a set of the one or more messages, said set of the one or more messages being indicative of an unknown status; and
specifying an second section of the inbox on the interface, said second section including the remaining set of the one or more messages, said remaining set of the messages being indicative of a known status.

15. The system of claim 14, wherein the known status includes at least one of the following status: a safe status and a contact status.

16. The system of claim 14, wherein the unknown status indicates the set of the one or more messages from the senders including at least one of the following properties: a message source not included in a contact list of the user, a message source not included in a safe list defined by the user, senders with frequent message communications but without a proper status, good reputation senders, mixed reputation senders, potentially dangerous senders, and changes to distinguishing message settings.

17. The system of claim 14, wherein the interface is further configured to receive an instruction from the user for modifying the unknown status of the one or more messages in the first section of the inbox on the interface.

18. The system of claim 17:
wherein the interface receives the instruction from the user for modifying the unknown status of the one or more messages in the first section of the inbox to the known status, and wherein the processor is configured to move at least to the following: the one or more messages with the known status from the first section of the inbox to the second section of the inbox and all future messages from the sender associated with the one or more messages,
wherein the interface receives the instruction from the user for modifying the unknown status of the one or more messages in the first section of the inbox to a unsafe status, and wherein the processor is configured to move at least to the following: the one or more messages with the unsafe status from the first section of the inbox to a junk e-mail storage, and all future messages from the sender associated with the one or more messages; or
wherein the interface receives the instruction from the user for modifying the unknown status of the one or more messages in the first section of the inbox to a deleted status, and wherein the processor is configured to remove the one or more messages with the deleted status from the first section of the inbox.

19. The system of claim 14, further comprising a filter for specifying the first section and the second section, said filter defining at least a low state, a standard state, and an exclusive state, wherein the low state, the standard state, and the exclusive state defining one or more messages from senders based on a function of the unknown status and the known status.

20. The system of claim 19, wherein the processor is configured to apply the filter to a junk folder, wherein the applied filter filters the one or more messages to the junk folder, the first section of the inbox, and the second section of the inbox as a function of the unknown status and the known status.
